(19) United States
(12) Patent Application Publication
(10) Pub. No.: US 2018/0010340 A1
(43) Pub. Date: Jan. 11, 2018

(54) Pest Control System

(71) Applicant: Albert Linson, Desoto, TX (US)

(72) Inventor: Albert Linson, Desoto, TX (US)

(21) Appl. No.: 15/205,188

(22) Filed: Jul. 8, 2016

(51) Int. Cl. E04D 13/00; A01M 29/30; E04B 1/72; E04D 12/00

(52) U.S. Cl. CPC E04D 13/004; E04D 12/00; A01M 29/30; E04B 1/72

(57) ABSTRACT

A pest control system for inhibiting and animal from chewing through a soffit includes a structure that has at least one pair of roof planes and a soffit. Each of the at least one pair of roof planes is covered with shingles. A spiked unit is provided. The spiked unit is coupled to the at least one pair of roof planes. Thus, the spiked unit may inhibit an animal from sitting on the at least one pair of roof planes. The spiked unit is positioned below the soffit. Thus, the spiked unit inhibits the animal from chewing through the soffit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to pest control devices and more particularly pertains to a new pest control device for inhibiting an animal from chewing through a soffit.

### BRIEF SUMMARY OF THE INVENTION

An embodiment of the disclosure meets the needs presented above by generally comprising a structure that has at least one pair of roof planes and a soffit. Each of the at least one pair of roof planes is covered with shingles. A spiked unit is provided. The spiked unit is coupled to the at least one pair of roof planes. Thus, the spiked unit may inhibit an animal from sitting on the at least one pair of roof planes. The spiked unit is positioned below the soffit. Thus, the spiked unit inhibits the animal from chewing through the soffit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a pest control system according to an embodiment of the disclosure.

FIG. 2 is a top perspective view of an embodiment of the disclosure.

FIG. 3 is a perspective view of an alternative embodiment of the disclosure.

FIG. 4 is a top perspective view of an alternative embodiment of the disclosure.

FIG. 5 is a front perspective view of an alternative embodiment of the disclosure.

FIG. 6 is an exploded view of an alternative embodiment of the disclosure.

FIG. 7 is an exploded perspective view of an alternative embodiment of the disclosure.

FIG. 8 is a perspective in-use view of an alternative embodiment of the disclosure.

### DETAILED DESCRIPTION OF THE INVENTION

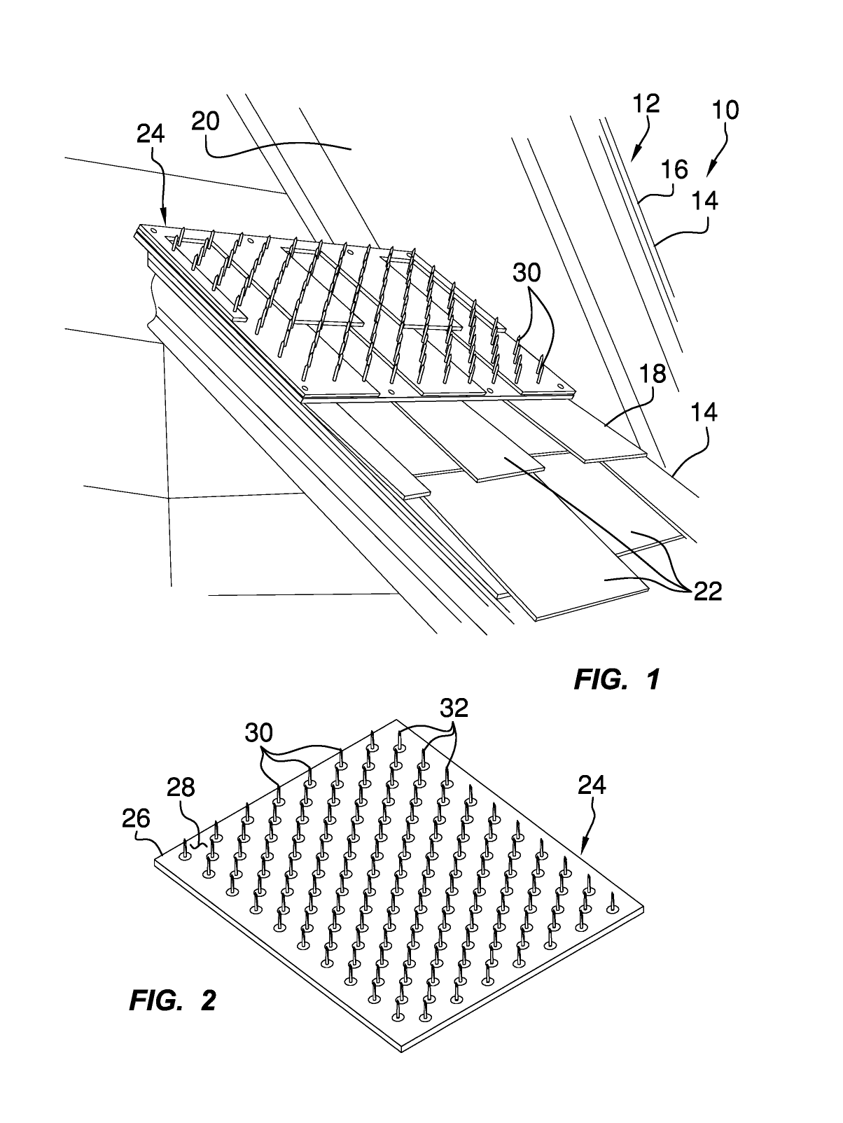

With reference now to the drawings, and in particular to FIGS. 1 through 8 thereof, a new pest control device embodying the principles and concepts of an embodiment of the disclosure and generally designated by the reference numeral 10 will be described.

As best illustrated in FIGS. 1 through 8, the pest control system 10 generally comprises a structure 12 that has at least one pair of roof planes 14. The at least one pair of roof planes 14 includes a first plane 16 and a second plane 18. The first plane 16 intersects the second plane 18. Thus, a soffit 20 corresponding to the first plane 16 is positioned above the second plane 18. Each of the at least one pair of roof planes 14 is covered with shingles 22. The structure 12 may comprise a house or the like.

A spiked unit 24 is provided. The spiked unit 24 is coupled to the at least one pair of roof planes 14. Thus, the spiked unit 24 may inhibit an animal from sitting on the at least one pair of roof planes 14. The spiked unit 24 is positioned below the soffit 20. Thus, the spiked unit 24 inhibits the animal from chewing through the soffit 20. The animal may be a squirrel or other rodent commonly associated with attic infiltration with respect to the structure 12.

The spiked unit 24 comprises a panel 26 that has a first surface 28. The panel 26 is positioned beneath the shingles 22 corresponding to the second plane 18. Thus, the panel 26 is positioned beneath the soffit 20. The panel 26 may be comprised of a translucent material. Thus, the panel 26 is inhibited from having visual contrast with respect to the shingles 22. Additionally, the panel 26 may be comprised of a fluid impermeable material.

A plurality of spikes 30 is provided. Each of the spikes 30 is coupled to and extends upwardly from the first surface 28. The spikes 30 are spaced apart from each other and are distributed on the first surface 28. Each of the spikes 30 may be comprised of a translucent material. Thus, each of the spikes 30 is inhibited from having visual contrast with respect to the shingles 22.

Each of the spikes 30 has a distal end 32 with respect to the first surface 28. The distal end 32 corresponding to each of the spikes 30 tapers to a point. Each of the spikes 30 extends upwardly through the shingles 22 corresponding to the second plane 18. The distal end 32 corresponding to each of the spikes 30 is exposed. Thus, the plurality of spikes 30 inhibits the animal from sitting on the shingles 22 beneath the soffit 20. Moreover, the spikes 30 inhibit the animal from chewing through the soffit 20.

A plurality of the spiked units 24 may be provided. The plurality of spiked units 24 may be distributed along entire length of the soffit 20 that extends over the second plane 18. Thus, the plurality of spiked units 24 may inhibit the animal from accessing the entire length of the soffit 20 that extends over the second plane 18.

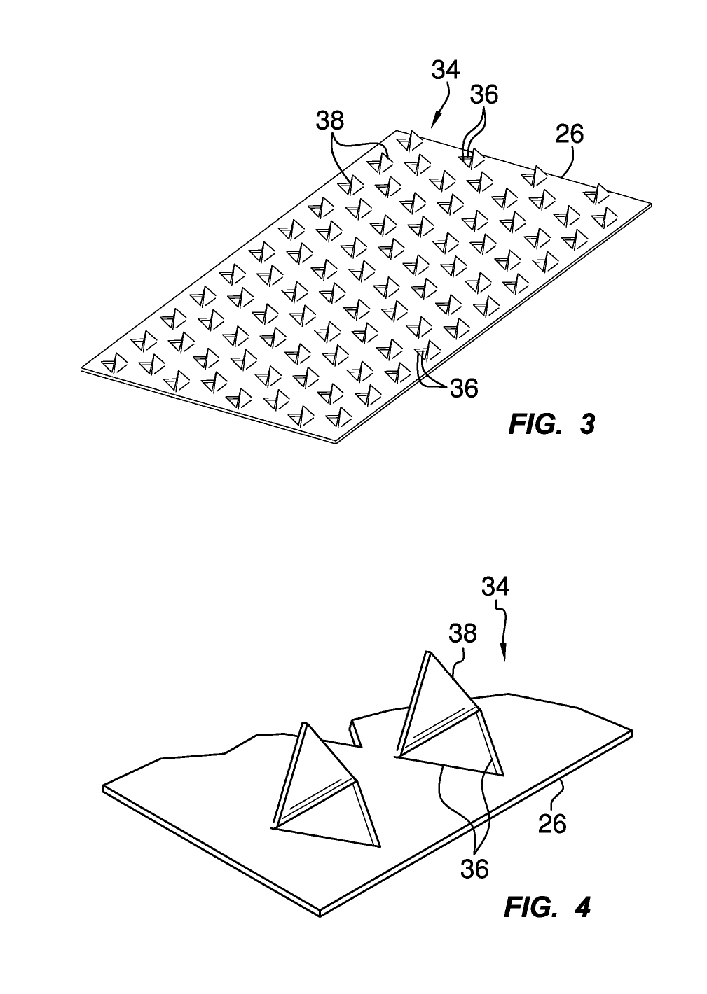

In an alternative embodiment 34 as shown in FIGS. 3 and 4, the panel 26 may have a plurality of cuts 36 extending therethrough. Each of the cuts 36 may define a tab 38. Moreover, the tab 38 defined by the cuts 36 may be bent to extend upwardly from the panel 26. Each of the tabs 38 may taper to a point. Thus, the tabs 36 may extend upwardly through the shingles 22.

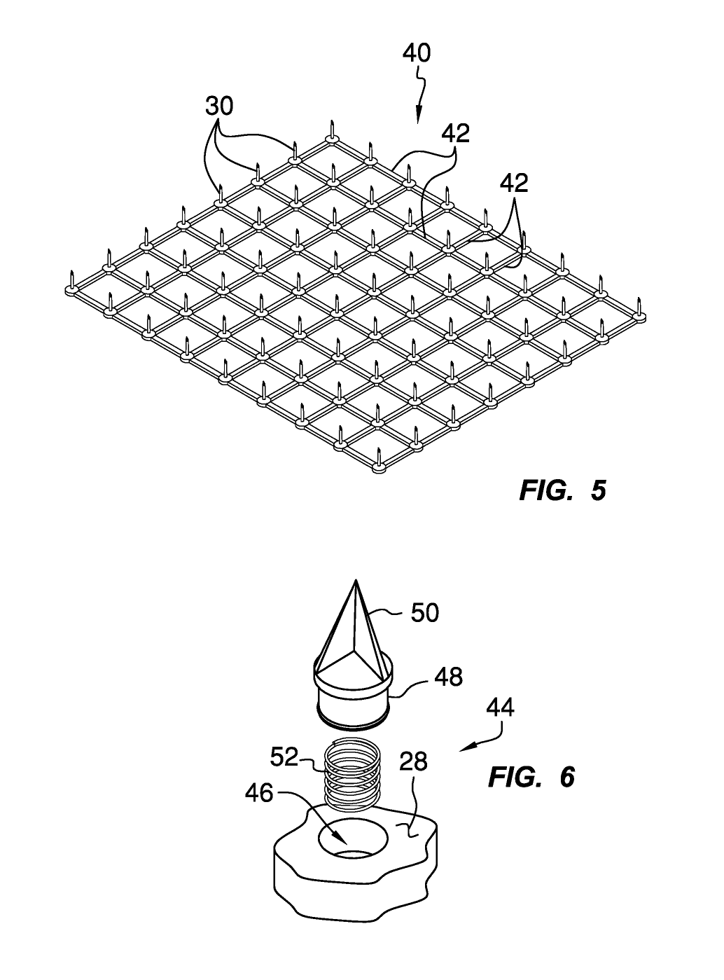

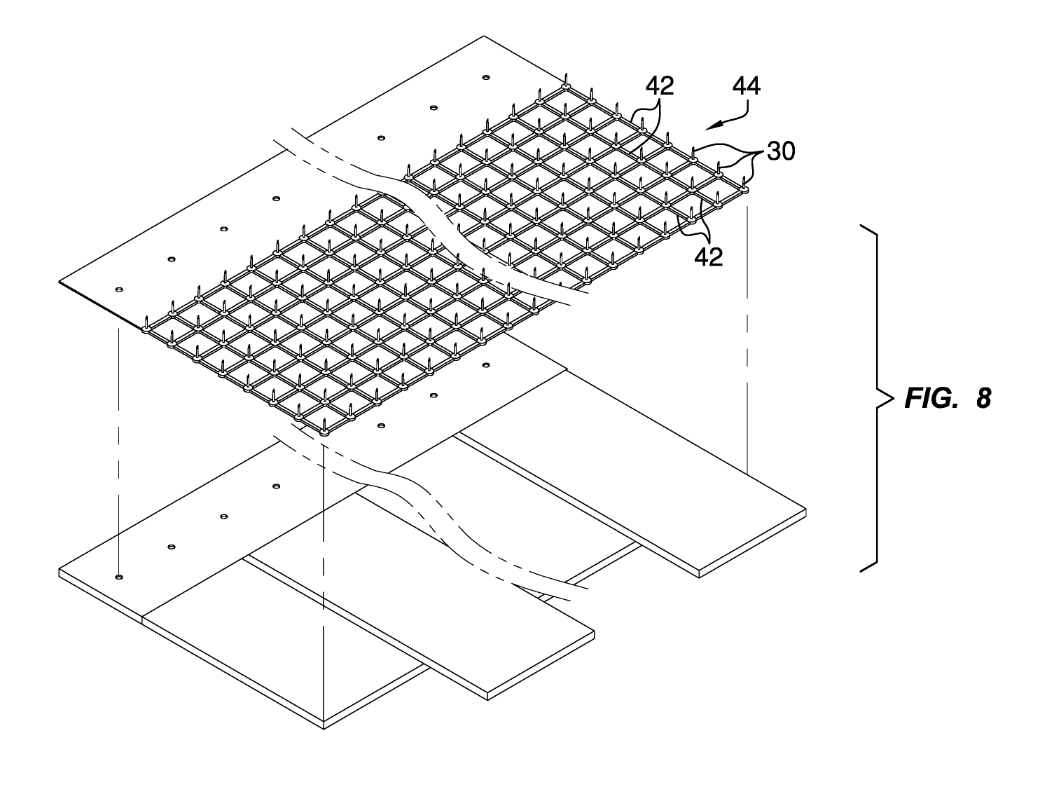

In an alternative embodiment 40 as shown in FIGS. 5 and 8, the panel 26 may be comprised of a plurality of intersecting members 42. The intersecting members 42 may be oriented to define a grid. Each of the spikes 30 may be positioned at an intersection of the intersecting members 42. The intersecting members 42 may be positioned on top of the shingles 22 corresponding to the second plane 18.

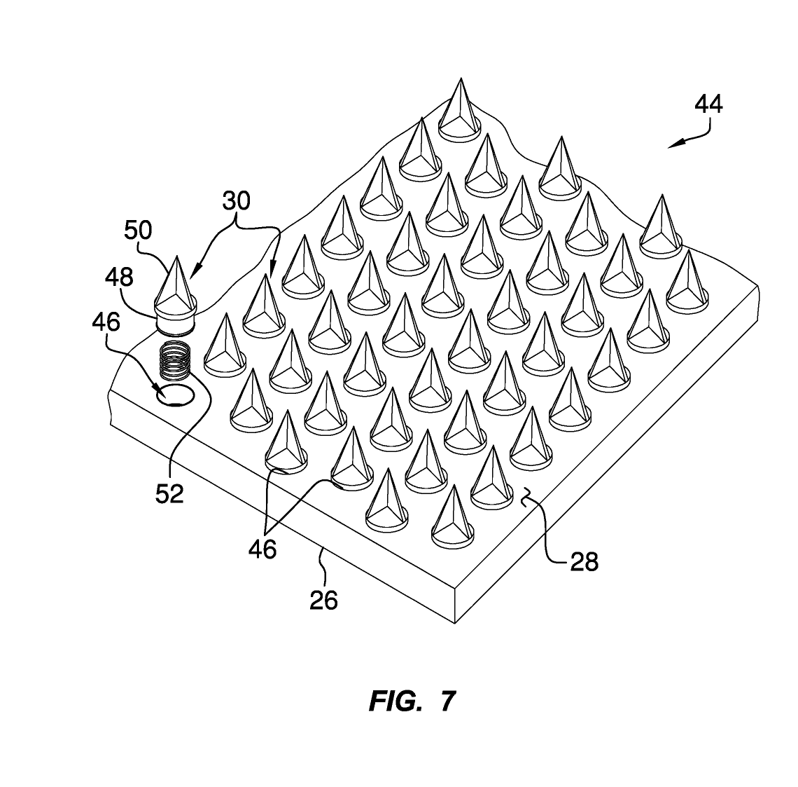

In an alternative embodiment 44 as shown in FIGS. 6 and 7, the first surface 28 of the panel 26 may have a plurality of wells 46 extending downwardly therein. The wells 46 may be spaced apart from each other and distributed on the panel 26. Each of the spikes 30 may include a base 48 and a point 50 extending upwardly from the base 48. Each of the spikes 30 may further include a biasing member 52.

The biasing member 52 corresponding to each of the spikes 30 may be positioned in an associated one of the wells 46. The base 48 corresponding to each of the spikes 30 may be positioned on the biasing member 52 in the associated wells 46. Thus, the biasing member 52 corresponding to each of the spikes 30 biases the point 50 corresponding to each of the spikes 30 upwardly from the associated well 46. The point 50 corresponding to each of the spikes 30 may extend upwardly through the shingles 22.

In use, the panel(s) 26 is/are positioned beneath the shingles 22 that are aligned with the soffit 20 above the second plane 18. The spikes 30 extend upwardly through the shingles 22 aligned with the soffit 20 above the second plane 18. Thus, the panel(s) 26 inhibits the animal from sitting on the shingles 22 that are aligned with the soffit 20. Moreover, the panel(s) 26 inhibits the animal from chewing through the soffit 20 and accessing an attic of the structure 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pest control system being configured to inhibit rodents from chewing through a soffit on a roof, said system comprising:
a structure having a pair of roof planes and a soffit, each of said roof planes being covered with shingles, said pair of roof planes including a first plane and a second plane, said first plane intersecting said second plane such that said soffit corresponding to said first plane is positioned above said second plane; and
a spiked unit being coupled to said at least one pair of roof planes wherein said spiked unit is configured to inhibit an animal from sitting on said at least one pair of roof planes, said spiked unit being positioned below said soffit wherein said spiked unit is configured to inhibit the animal from chewing through said soffit.

2. (canceled)

3. The system according to claim 1, wherein
said spiked unit comprises a panel having a first surface, said panel being positioned beneath said shingles corresponding to said second plane such that said panel is positioned beneath said soffit.

4. The system according to claim 3, further comprising a plurality of spikes, each of said spikes being coupled to and extending upwardly from said first surface, said spikes being spaced apart from each other and being distributed on said first surface, each of said spikes having a distal end with respect to said first surface.

5. The system according to claim 4, wherein each of said spikes extends upwardly through said shingles corresponding to said second plane having said distal end corresponding to each of said spikes being exposes wherein said plurality of spikes is configured to inhibit the animal from sitting on said shingles beneath said soffit thereby inhibiting the animal from chewing through said soffit.

6. A pest control system being configured to inhibit rodents from chewing through a soffit on a roof, said system comprising:
a structure having a pair of roof planes, said pair of roof planes including a first plane and a second plane, said first plane intersecting said second plane such that a soffit corresponding to said first plane is positioned above said second plane, each of said pair of roof planes being covered with shingles; and
a spiked unit being coupled to said at least one pair of roof planes wherein said spiked unit is configured to inhibit an animal from sitting on said at least one pair of roof planes, said spiked unit being positioned below said soffit wherein said spiked unit is configured to inhibit the animal from chewing through said soffit, said spiked unit comprising:
a panel having a first surface, said panel being positioned beneath said shingles corresponding to said second plane such that said panel is positioned beneath said soffit, and
a plurality of spikes, each of said spikes being coupled to and extending upwardly from said first surface, said spikes being spaced apart from each other and being distributed on said first surface, each of said spikes having a distal end with respect to said first surface, each of said spikes extending upwardly through said shingles corresponding to said second plane having said distal end corresponding to each of said spikes being exposes wherein said plurality of spikes is configured to inhibit the animal from sitting on said shingles beneath said soffit thereby inhibiting the animal from chewing through said soffit.
